(19) United States
(12) Patent Application Publication
(10) Pub. No.: US 2017/0225440 A1
(43) Pub. Date: Aug. 10, 2017

(54) Multilayer Polymer Films Having Improved Barrier Properties

(71) Applicant: Chevron Phillips Chemical Company LP, The Woodlands, TX (US)

(72) Inventors: Mark L. HLAVINKA, Bartlesville, OK (US); Charles D. MILLS, Owasso, OK (US); Qing YANG, Bartlesville, OK (US); Guylaine ST. JEAN, Bartlesville, OK (US)

(21) Appl. No.: 15/453,393

(22) Filed: Mar. 8, 2017

Related U.S. Application Data
(63) Continuation of application No. 13/224,785, filed on Sep. 2, 2011, now abandoned.

(51) Int. Cl. B32B 27/32; B32B 27/08

(52) U.S. Cl. CPC B32B 27/327; B32B 27/08; B32B 2250/03; B32B 2250/242; B32B 2307/724

(57) ABSTRACT

A multilayer polymer film comprising an outer skin layer, an inner seal layer and at least one core layer disposed between the inner and outer skin layer, wherein the outer skin layers comprises a metallocene-catalyzed ethylene polymer having a density of equal to or greater than about 0.945 g/cc and a melt index equal to or greater than 0.5 g/10 min. A multilayer polymer film comprising a metallocene-catalyzed high-density polyethylene homopolymer skin layer and at least one core layer comprising a high-density polyethylene having a melt index of less than or equal to 2.0 g/10 min. A multilayer polymer film comprising at least a skin layer and a core layer wherein the skin layer comprises a metallocene-catalyzed ethylene polymer provided from a catalyst composition comprising a single metallocene and an activator support.

### CROSS-REFERENCE TO RELATED APPLICATIONS

The present application is a continuation of and claims priority to U.S. patent application Ser. No. 13/224,785 filed Sep. 2, 2011, published as U.S. Patent Application Publication No. 2013/0059140 A1, and entitled “Multilayer Polymer Films Having Improved Barrier Properties,” which application is incorporated herein by reference as if produced in its entirety.

The subject matter of the present application is related to U.S. patent application Ser. No. 13/306,321 filed Nov. 29, 2011, now U.S. Pat. No. 9,284,391, and entitled “Polymer Compositions Having Improved Barrier Properties,” and U.S. patent application Ser. No. 13/224,775 filed Sep. 2, 2011, now U.S. Pat. No. 9,018,329, and entitled “Polymer Compositions Having Improved Barrier Properties,” each of which is hereby incorporated herein by reference in its entirety for all purposes.

### FIELD OF THE INVENTION

The present disclosure relates to polymeric compositions, more specifically polyethylene (PE) compositions having improved barrier properties and multilayer films prepared from same.

### BACKGROUND OF THE INVENTION

Polyolefins are plastic materials useful for making a wide variety of valued products due to their combination of stiffness, ductility, barrier properties, temperature resistance, optical properties, availability, and low cost. One of the most valued products is plastic films. In particular, PE is the one of the largest volume polymers consumed in the world. It is a versatile polymer that offers high performance relative to other polymers and alternative materials such as glass, metal or paper. Plastic films such as PE films are mostly used in packaging applications but they also find utility in the agricultural, medical, and engineering fields.

PE films are manufactured in a variety of grades that are usually differentiated by the polymer density such that PE films can be designated for example, low density polyethylene (LDPE), linear low density polyethylene (LLDPE), medium density polyethylene (MDPE), and high density polyethylene (HDPE), wherein each density range has a unique combination of properties making it suitable for a particular application. Many industries, such as the packaging industry, utilize these films in various manufacturing processes to create a variety of finished goods including containers, packaging films for food packaging, thermo-lamination films, heavy duty shipping sacks for packaging industrial and consumer chemicals, etc. The various types of polyethylene are also used in combination with other non-polyolefin and polyolefin type resins, such as nylon, polypropylene, polystyrene, etc. to achieve a variety of performance properties. These particular combinations can be manufactured using a number of processing techniques such as coextrusion, lamination and coating.

One limit to the utility of these films in applications such as food packaging is the extent to which the films are permeable to gases and/or moisture or serve as a barrier to these materials. Thus, an ongoing need exists to develop PE films exhibiting improved barrier properties.

### SUMMARY OF THE INVENTION

Disclosed herein is a multilayer polymer film comprising an outer skin layer, an optional inner seal layer and at least one core layer disposed between the optional inner seal layer and outer skin layer, wherein the outer skin layer comprises a metallocene-catalyzed ethylene polymer having a density of equal to or greater than about 0.945 g/cc and a melt index equal to or greater than 0.5 g/10 min.

Further disclosed herein is a multilayer polymer film comprising a metallocene-catalyzed high-density polyethylene homopolymer skin layer and at least one core layer comprising a high-density polyethylene having a melt index of less than or equal to 2.0 g/10 min.

Also disclosed herein is a multilayer polymer film comprising at least a skin layer and a core layer wherein the skin layer comprises a metallocene-catalyzed ethylene polymer provided from a catalyst composition comprising a single metallocene and an activator support.

### BRIEF DESCRIPTION OF THE DRAWINGS

FIG. 1 is an illustration of a multilayer polymer film.

FIG. 2 is a plot of the percent improvement in the moisture vapor transmission rate as a function of gauge for the samples from example 1.

FIG. 3 is a plot of the moisture vapor transmission rate as a function of gauge for the samples from example 1.

### DETAILED DESCRIPTION

Disclosed herein are multilayer polymer films (MPF) comprising an optional inner seal layer, an outer skin layer, and at least one core layer disposed between the optional inner seal layer and outer skin layer. In an embodiment, the skin layer displays improved barrier properties such as a decreased moisture vapor transmission rate (MVTR).

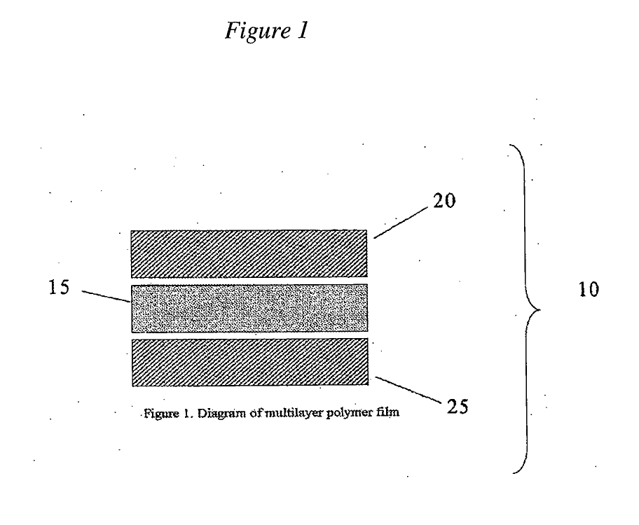

Referring to an aspect shown in FIG. 1, a MPF 10 can comprise at least three layers: at least one core layer 15 disposed between an outer skin layer 20 and an inner seal layer 25. The term “skin layer” refers to the outermost layer 20 of the film and the “seal layer” refers to the innermost layer of the film 25. The inner seal layer 25 is typically in contact with a packaged product such as a food item, and the outer skin layer 20 may be printed or otherwise decorated. The term “core layer” refers to one or more layers 15 disposed between the skin and seal layers. The core layer may comprise one layer or multiple layers. In aspects having multiple core layers, the term “central core layer” refers to an innermost or primary core layer having one or more “intermediate core layers” disposed between the central core layer and the outer skin layer 20, one or more intermediate core layers disposed between the central core layer and the inner seal layer 25. Typically, an equal number of intermediate core layers are present on either side of the central core layer. The intermediate core layers may be the same as or different than the central core layer. For example, the intermediate core layers may be of like or varying thickness and/or composition than the central core layer. In an aspect, the central core layer and the intermediate core layers have about the same size and/or composition. In an aspect, multiple core layers of like composition and thickness may be laminated or otherwise function together such that they form a functional equivalent of a single, uniform core layer. As used herein, the terms “core layer” and “multiple core layers” includes the central core layer and any intermediate core layers, when present.

In an aspect, a MPF 10 comprises three layers as is shown in FIG. 1: a single core layer 15 disposed between an outer skin layer 20 and an inner seal layer 25. In an aspect, the MPF 10 comprises five layers: a core layer 15 disposed between the outer skin layer 20 and the inner seal layer 25, wherein the core layer 15 further comprises a central core layer equally disposed between 2 intermediate core layers. In an aspect, the MPF may comprise seven layers: a core layer 15 disposed between the outer skin layer 20 and the inner seal layer 25, wherein the core layer 15 further comprises a central core layer equally disposed between 4 intermediate core layers (e.g., tow on each side). In various aspects, any suitable number of core layers may be disposed between the skin layer 20 and the seal layer 25.

In some embodiments, the MPF comprises at least 5 layers, alternatively at least 7 layers, or alternatively at least 9 layers. Hereinafter, for simplicity, the discussion will refer to MPFs having three layers although it is to be understood that MPFs having greater than three layers are also contemplated.

In an embodiment, the MPF comprises a skin layer comprising a metallocene-catalyzed polyethylene homopolymer (m-PE homopolymer). It is to be understood that an inconsequential amount of comonomer may be present in the m-PE homopolymer and the polymer still be considered a homopolymer. Herein, an inconsequential amount of a comonomer refers to an amount that does not substantively affect the properties of the polymer disclosed herein. For example, a comonomer can be present in an amount of less than about 0.5 wt. %, 0.1 wt. %, or 0.01 wt. % based on the total weight of polymer.

In an embodiment, a m-PE homopolymer suitable for use in the skin layers is characterized by a density of equal to or greater than about 0.945 g/cc, alternatively greater than about 0.950 g/cc, alternatively greater than about 0.955 g/cc, or alternatively greater than about 0.960 g/cc as determined in accordance with ASTM D 1505.

In an embodiment, a m-PE homopolymer suitable for use in the skin layer is a unimodal resin. Herein, the “modality” of a polymer resin refers to the form of its molecular weight distribution curve, i.e. the appearance of the graph of the polymer weight fraction as a function of its molecular weight. The polymer weight fraction refers to the weight fraction of molecules of a given size. A polymer having a molecular weight distribution curve showing a single peak may be referred to as a unimodal polymer, a polymer having curve showing two distinct peaks may be referred to as bimodal polymer, a polymer having a curve showing three distinct peaks may be referred to as trimodal polymer, etc.

In an embodiment, a m-PE homopolymer suitable for use in the skin layer has a weight average molecular weight (M_{w}) of from about 80 kg/mol to about 200 kg/mol; alternatively of from about 90 kg/mol to about 175 kg/mol; or alternatively of from about 100 kg/mol to about 150 kg/mol. The weight average molecular weight describes the molecular weight distribution of a polymer and is calculated according to equation 1:

$${M}_{w} = \frac{{\sum }_{i} {N}_{i} {M}_{i}^{2} }{{\sum }_{i} {N}_{i} {M}_{i}} \qquad ( 1 )$$

where Nᵢ is the number of molecules of molecular weight Mᵢ.

A m-PE homopolymer suitable for use in the skin layer may be characterized by a molecular weight distribution (MWD) of from about 2 to about 5, alternatively from about 2 to about 4.5, or alternatively from about 2 to about 4. The MWD is the ratio of the M_{w} to the number average molecular weight (Mₙ), which is also referred to as the polydispersity index (PDI) or more simply as polydispersity. The number average molecular weight is the common average of the molecular weights of the individual polymers and may be calculated according to equation (2) where Nᵢ is the number of molecules of molecular weight Mᵢ.

$${M}_{n} = \frac{{\sum }_{i} {N}_{i} {M}_{i} }{{\sum }_{i} {N}_{i}} \qquad ( 2 )$$

A m-PE homopolymer suitable for use in the skin layer may be further characterized by a ratio of z-average molecular weight (M_{z}) to M_{w} (M_{z}/ M_{w}) of less than about 4, alternatively less than about 3.5, or alternatively less than about 3. The z-average molecular weight is a higher order molecular weight average which is calculated according to equation (3)

M_{z}=ΣᵢNᵢMᵢ³/ΣᵢNᵢMᵢ² (3)

where Nᵢ is the number of molecules of molecular weight Mᵢ. The ratio of M_{z}/M_{w} is another indication of the breadth of the MWD of a polymer.

In an embodiment, a m-PE homopolymer suitable for use in the skin layer has a melt index, MI, in the range of from about 0.5 grams per 10 minutes (g/10 min) to about 4.0 g/10 min, alternatively from about 0.7 g/10 min to about 3.0 g/10 min, or alternatively from about 0.75 g/10 min to about 2.75 g/10 min. The melt index (MI) refers to the amount of a polymer which can be forced through an melt indexer orifice of 0.0825 inch diameter when subjected to a force of 2160 grams in ten minutes at 190° C., as determined in accordance with ASTM D 1238.

In an embodiment, the m-PE when formed into a single layer film displays a MVTR of less than or equal to about 0.55 grams-mil per 100 square inch per day (g-mil/100 in²/day), alternatively less than or equal to about 0.44 g-mil/100 in²/day, or alternatively less than or equal to about 0.39 g-mil/100 in²/day at 1 mil thickness as measured in accordance with ASTM F 1249. The MVTR measures passage of gaseous H₂O through a barrier. The MVTR may also be referred to as the water vapor transmission rate (WVTR). Typically, the MVTR is measured in a special chamber, divided vertically by the substrate/barrier material. A dry atmosphere is in one chamber, and a moist atmosphere is in the other. A 24-hour test is run to see how much moisture passes through the substrate/barrier from the “wet” chamber to the “dry” chamber under conditions which can specify any one of five combinations of temperature and humidity in the “wet” chamber.

In an embodiment, the m-PE when formed into a single layer film displays improved optical properties. For example, said films may display reduced haze. Generally, haze refers to the cloudy appearance of a material cause by light scattered from within the material or from its surface. Herein, the values of haze disclosed refer to the percentage of transmitted light that scatters or deviates from an incident beam by more than 2.5° (angle degrees). The haze of a material can be determined in accordance with ASTM D1003-00 for a haze percentage of equal to or lower than 30%. In an embodiment, films produced from an m-PE homopolymer of the type described herein may have a haze percentage of less about 45%, alternatively less than about 35%, or alternatively less than about 25% as determined in accordance with ASTM D1003 for a density of 0.949 g/cc or greater.

m-PE homopolymers suitable for use in the skin layers of a MPF may be prepared by any suitable methodology. For example, the m-PE homopolymer may be prepared by a method comprising contacting an olefin and/or alpha-olefin monomer with a catalyst system under conditions suitable for the formation of the m-PE homopolymer. In an embodiment, a catalyst composition for the production of a m-PE homopolymer herein may comprise a single metallocene compound; an activator support, and an organoaluminum compound. Herein, the term “metallocene” describes a compound comprising at least one η³ to η⁵-cycloalkadienyl-type moiety, wherein η³ to η⁵-cycloalkadienyl moieties include cyclopentadienyl ligands, indenyl ligands, fluorenyl ligands, and the like, including partially saturated or substituted derivatives or analogs of any of these. Possible substituents on these ligands include hydrogen, therefore the description “substituted derivatives thereof” in this disclosure comprises partially saturated ligands such as tetrahydroindenyl, tetrahydrofluorenyl, octahydrofluorenyl, partially saturated indenyl, partially saturated fluorenyl, substituted partially saturated indenyl, substituted partially saturated fluorenyl, and the like.

In an embodiment, the metallocene comprises a tightly-bridged ansa-metallocene compound comprising an olefin-containing moiety bonded to a cyclopentadienyl-type ligand and at least one aryl group bonded to the bridging atom of the bridging ligand. As used herein, the term bridged or ansa-metallocene refers simply to a metallocene compound in which the two η⁵-cycloalkadienyl-type ligands in the molecule are linked by a bridging moiety. Useful ansa-metallocenes are typically “tightly-bridged”, meaning that the two η⁵-cycloalkadienyl-type ligands are connected by a bridging group wherein the shortest link of the bridging moiety between the η⁵-cycloalkadienyl-type ligands is a single atom. Thus, the length of the bridge or the chain between the two η⁵-cycloalkadienyl-type ligands is one atom, although this bridging atom is substituted. The metallocenes of this disclosure are therefore bridged bis(η⁵-cycloalkadienyl)-type compounds, wherein the η⁵-cycloalkadienyl portions include substituted cyclopentadienyl ligands, substituted indenyl ligands, substituted fluorenyl ligands, and the like, wherein one substituent on these cyclopentadienyl-type ligands is a bridging group having the formula ER¹R², wherein E is a carbon atom, a silicon atom, a germanium atom, or a tin atom, and wherein E is bonded to both cyclopentadienyl-type ligands. In this aspect, R¹ and R² can be independently selected from an alkyl group or an aryl group, either of which having up to 12 carbon atoms, or hydrogen. A metallocene compound suitable for use in the present disclosure may display a positive hydrogen response. Herein, a positive hydrogen response refers to a lowering of the molecular weight. Examples of metallocene compounds suitable for use in the present disclosure are described in more detail in U.S. Pat. Nos. 7,064,225; 7,226,886 and 7,517,939; each of which is incorporated herein by reference in its entirety. In one aspect, the activator-support comprises a chemically-treated solid oxide. Alternatively, the activator-support can comprise a clay mineral, a pillared clay, an exfoliated clay, an exfoliated clay gelled into another oxide matrix, a layered silicate mineral, a non-layered silicate mineral, a layered aluminosilicate mineral, a non-layered aluminosilicate mineral, or any combination thereof.

Generally, chemically-treated solid oxides exhibit enhanced acidity as compared to the corresponding untreated solid oxide compound. The chemically-treated solid oxide also functions as a catalyst activator as compared to the corresponding untreated solid oxide. While the chemically-treated solid oxide activates the metallocene(s) in the absence of co-catalysts, it is not necessary to eliminate co-catalysts from the catalyst composition. The activation function of the activator-support is evident in the enhanced activity of catalyst composition as a whole, as compared to a catalyst composition containing the corresponding untreated solid oxide. However, it is believed that the chemically-treated solid oxide can function as an activator, even in the absence of an organoaluminum compound, aluminoxanes, organoboron or organoborate compounds, ionizing ionic compounds, and the like.

The chemically-treated solid oxide can comprise a solid oxide treated with an electron-withdrawing anion. While not intending to be bound by the following statement, it is believed that treatment of the solid oxide with an electron-withdrawing component augments or enhances the acidity of the oxide. Thus, either the activator-support exhibits Lewis or Brønsted acidity that is typically greater than the Lewis or Brønsted acid strength of the untreated solid oxide, or the activator-support has a greater number of acid sites than the untreated solid oxide, or both. One method to quantify the acidity of the chemically-treated and untreated solid oxide materials is by comparing the polymerization activities of the treated and untreated oxides under acid catalyzed reactions.

Chemically-treated solid oxides of this disclosure are formed generally from an inorganic solid oxide that exhibits Lewis acidic or Brønsted acidic behavior and has a relatively high porosity. The solid oxide is chemically-treated with an electron-withdrawing component, typically an electron-withdrawing anion, to form an activator-support.

According to one aspect of the present disclosure, the solid oxide used to prepare the chemically-treated solid oxide has a pore volume greater than about 0.1 cc/g. According to another aspect of the present disclosure, the solid oxide has a pore volume greater than about 0.5 cc/g. According to yet another aspect of the present disclosure, the solid oxide has a pore volume greater than about 1.0 cc/g.

In another aspect, the solid oxide has a surface area of from about 100 m²/g to about 1000 m²/g. In yet another aspect, the solid oxide has a surface area of from about 200 m²/g to about 800 m²/g. In still another aspect of the present disclosure, the solid oxide has a surface area of from about 250 m²/g to about 600 m²/g.

The chemically-treated solid oxide can comprise a solid inorganic oxide comprising oxygen and one or more elements selected from Group 2, 3, 4, 5, 6, 7, 8, 9, 10, 11, 12, 13, 14, or 15 of the periodic table, or comprising oxygen and one or more elements selected from the lanthanide or actinide elements (See: Hawley's Condensed Chemical Dictionary, 11th Ed., John Wiley & Sons, 1995; Cotton, F. A., Wilkinson, G., Murillo, C. A., and Bochmann, M., Advanced Inorganic Chemistry, 6th Ed., Wiley-Interscience, 1999). For example, the inorganic oxide can comprise oxygen and an element, or elements, selected from Al, B, Be, Bi, Cd, Co, Cr, Cu, Fe, Ga, La, Mn, Mo, Ni, Sb, Si, Sn, Sr, Th, Ti, V, W, P, Y, Zn, and Zr.

Suitable examples of solid oxide materials or compounds that can be used to form the chemically-treated solid oxide include, but are not limited to, Al₂O₃, B₂O₃, BeO, Bi₂O₃, CdO, Co₃O₄, Cr₂O₃, CuO, Fe₂O₃, Ga₂O₃, La₂O₃, Mn₂O₃, MoO₃, NiO, P₂O₅, Sb₂O₅, SiO₂, SnO₂, SrO, ThO₂, TiO₂, V₂O₅, WO₃, Y₂O₃, ZnO, ZrO₂, and the like, including mixed oxides thereof, and combinations thereof. For example, the solid oxide can comprise silica, alumina, silica-alumina, silica-coated alumina, aluminum phosphate, aluminophosphate, heteropolytungstate, titania, zirconia, magnesia, boria, zinc oxide, mixed oxides thereof, or any combination thereof.

The solid oxide of this disclosure encompasses oxide materials such as alumina, “mixed oxide” compounds thereof such as silica-alumina, and combinations and mixtures thereof. The mixed oxide compounds such as silica-alumina can be single or multiple chemical phases with more than one metal combined with oxygen to form a solid oxide compound. Examples of mixed oxides that can be used in the activator-support of the present disclosure include, but are not limited to, silica-alumina, silica-titania, silica-zirconia, zeolites, various clay minerals, alumina-titania, alumina-zirconia, zinc-aluminate, alumina-boria, silica-boria, aluminophosphate-silica, titania-zirconia, and the like. The solid oxide of this disclosure also encompasses oxide materials such as silica-coated alumina, as described in U.S. Pat. No. 7,884,163, the disclosure of which is incorporated herein by reference in its entirety.

The electron-withdrawing component used to treat the solid oxide can be any component that increases the Lewis or Brønsted acidity of the solid oxide upon treatment (as compared to the solid oxide that is not treated with at least one electron-withdrawing anion). According to one aspect of the present disclosure, the electron-withdrawing component is an electron-withdrawing anion derived from a salt, an acid, or other compound, such as a volatile organic compound, that serves as a source or precursor for that anion. Examples of electron-withdrawing anions include, but are not limited to, sulfate, bisulfate, fluoride, chloride, bromide, iodide, fluorosulfate, fluoroborate, phosphate, fluorophosphate, trifluoroacetate, triflate, fluorozirconate, fluorotitanate, phospho-tungstate, and the like, including mixtures and combinations thereof. In addition, other ionic or non-ionic compounds that serve as sources for these electron-withdrawing anions also can be employed in the present disclosure. It is contemplated that the electron-withdrawing anion can be, or can comprise, fluoride, chloride, bromide, phosphate, triflate, bisulfate, or sulfate, and the like, or any combination thereof, in some aspects of this disclosure. In other aspects, the electron-withdrawing anion can comprise sulfate, bisulfate, fluoride, chloride, bromide, iodide, fluorosulfate, fluoroborate, phosphate, fluorophosphate, trifluoroacetate, triflate, fluorozirconate, fluorotitanate, and the like, or any combination thereof.

Thus, for example, the activator-support (e.g., chemically-treated solid oxide) used in the catalyst compositions can be, or can comprise, fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, sulfated silica-coated alumina, phosphated silica-coated alumina, and the like, or combinations thereof. In one aspect, the activator-support can be, or can comprise, fluorided alumina, sulfated alumina, fluorided silica-alumina, sulfated silica-alumina, fluorided silica-coated alumina, sulfated silica-coated alumina, phosphated silica-coated alumina, and the like, or any combination thereof. In another aspect, the activator-support comprises fluorided alumina; alternatively, comprises chlorided alumina; alternatively, comprises sulfated alumina; alternatively, comprises fluorided silica-alumina; alternatively, comprises sulfated silica-alumina; alternatively, comprises fluorided silica-zirconia; alternatively, comprises chlorided silica-zirconia; or alternatively, comprises fluorided silica-coated alumina.

When the electron-withdrawing component comprises a salt of an electron-withdrawing anion, the counterion or cation of that salt can be selected from any cation that allows the salt to revert or decompose back to the acid during calcining. Factors that dictate the suitability of the particular salt to serve as a source for the electron-withdrawing anion include, but are not limited to, the solubility of the salt in the desired solvent, the lack of adverse reactivity of the cation, ion-pairing effects between the cation and anion, hygroscopic properties imparted to the salt by the cation, and the like, and thermal stability of the anion. Examples of suitable cations in the salt of the electron-withdrawing anion include, but are not limited to, ammonium, trialkyl ammonium, tetraalkyl ammonium, tetraalkyl phosphonium, H⁺, [H(OEt₂)₂]⁺, and the like.

Further, combinations of one or more different electron-withdrawing anions, in varying proportions, can be used to tailor the specific acidity of the activator-support to the desired level. Combinations of electron-withdrawing components can be contacted with the oxide material simultaneously or individually, and in any order that affords the desired chemically-treated solid oxide acidity. For example, one aspect of this disclosure is employing two or more electron-withdrawing anion source compounds in two or more separate contacting steps.

Thus, one example of such a process by which a chemically-treated solid oxide is prepared is as follows: a selected solid oxide, or combination of solid oxides, is contacted with a first electron-withdrawing anion source compound to form a first mixture; this first mixture is calcined and then contacted with a second electron-withdrawing anion source compound to form a second mixture; the second mixture is then calcined to form a treated solid oxide. In such a process, the first and second electron-withdrawing anion source compounds can be either the same or different compounds.

According to another aspect of the present disclosure, the chemically-treated solid oxide comprises a solid inorganic oxide material, a mixed oxide material, or a combination of inorganic oxide materials, that is chemically-treated with an electron-withdrawing component, and optionally treated with a metal source, including metal salts, metal ions, or other metal-containing compounds. Nonlimiting examples of the metal or metal ion include zinc, nickel, vanadium, titanium, silver, copper, gallium, tin, tungsten, molybdenum, zirconium, and the like, or combinations thereof. Examples of chemically-treated solid oxides that contain a metal or metal ion include, but are not limited to, chlorided zinc-impregnated alumina, fluorided titanium-impregnated alumina, fluorided zinc-impregnated alumina, chlorided zinc-impregnated silica-alumina, fluorided zinc-impregnated silica-alumina, sulfated zinc-impregnated alumina, chlorided zinc aluminate, fluorided zinc aluminate, sulfated zinc aluminate, silica-coated alumina treated with hexafluorotitanic acid, silica-coated alumina treated with zinc and then fluorided, and the like, or any combination thereof.

Any method of impregnating the solid oxide material with a metal can be used. The method by which the oxide is contacted with a metal source, typically a salt or metal-containing compound, can include, but is not limited to, gelling, co-gelling, impregnation of one compound onto another, and the like. If desired, the metal-containing compound is added to or impregnated into the solid oxide in solution form, and subsequently converted into the supported metal upon calcining. Accordingly, the solid inorganic oxide can further comprise a metal selected from zinc, titanium, nickel, vanadium, silver, copper, gallium, tin, tungsten, molybdenum, and the like, or combinations of these metals. For example, zinc is often used to impregnate the solid oxide because it can provide improved catalyst activity at a low cost.

The solid oxide can be treated with metal salts or metal-containing compounds before, after, or at the same time that the solid oxide is treated with the electron-withdrawing anion. Following any contacting method, the contacted mixture of solid compound, electron-withdrawing anion, and the metal ion is typically calcined. Alternatively, a solid oxide material, an electron-withdrawing anion source, and the metal salt or metal-containing compound are contacted and calcined simultaneously.

Various processes are used to form the chemically-treated solid oxide useful in the present disclosure. The chemically-treated solid oxide can comprise the contact product of one or more solid oxides with one or more electron-withdrawing anion sources. It is not required that the solid oxide be calcined prior to contacting the electron-withdrawing anion source. The contact product typically is calcined either during or after the solid oxide is contacted with the electron-withdrawing anion source. The solid oxide can be calcined or uncalcined. Various processes to prepare solid oxide activator-supports that can be employed in this disclosure have been reported. For example, such methods are described in U.S. Pat. Nos. 6,107,230; 6,165,929; 6,294,494; 6,300,271; 6,316,553; 6,355,594; 6,376,415; 6,388,017; 6,391,816; 6,395,666; 6,524,987; 6,548,441; 6,548,442; 6,576,583; 6,613,712; 6,632,894; 6,667,274; and 6,750,302; the disclosures of which are incorporated herein by reference in their entirety.

According to one aspect of the present disclosure, the solid oxide material is chemically-treated by contacting it with an electron-withdrawing component, typically an electron-withdrawing anion source. Further, the solid oxide material optionally is chemically treated with a metal ion, and then calcined to form a metal-containing or metal-impregnated chemically-treated solid oxide. According to another aspect of the present disclosure, the solid oxide material and electron-withdrawing anion source are contacted and calcined simultaneously.

The method by which the oxide is contacted with the electron-withdrawing component, typically a salt or an acid of an electron-withdrawing anion, can include, but is not limited to, gelling, co-gelling, impregnation of one compound onto another, and the like. Thus, following any contacting method, the contacted mixture of the solid oxide, electron-withdrawing anion, and optional metal ion, is calcined.

The solid oxide activator-support (i.e., chemically-treated solid oxide) thus can be produced by a process comprising:

1) contacting a solid oxide (or solid oxides) with an electron-withdrawing anion source compound (or compounds) to form a first mixture; and

2) calcining the first mixture to form the solid oxide activator-support.

According to another aspect of the present disclosure, the solid oxide activator-support (chemically-treated solid oxide) is produced by a process comprising:

1) contacting a solid oxide (or solid oxides) with a first electron-withdrawing anion source compound to form a first mixture;

2) calcining the first mixture to produce a calcined first mixture;

3) contacting the calcined first mixture with a second electron-withdrawing anion source compound to form a second mixture; and

4) calcining the second mixture to form the solid oxide activator-support.

According to yet another aspect of the present disclosure, the chemically-treated solid oxide is produced or formed by contacting the solid oxide with the electron-withdrawing anion source compound, where the solid oxide compound is calcined before, during, or after contacting the electron-withdrawing anion source, and where there is a substantial absence of aluminoxanes, organoboron or organoborate compounds, and ionizing ionic compounds.

Calcining of the treated solid oxide generally is conducted in an ambient atmosphere, typically in a dry ambient atmosphere, at a temperature from about 200° C. to about 900° C., and for a time of about 1 minute to about 100 hours. Calcining can be conducted at a temperature of from about 300° C. to about 800° C., or alternatively, at a temperature of from about 400° C. to about 700° C. Calcining can be conducted for about 30 minutes to about 50 hours, or for about 1 hour to about 15 hours. Thus, for example, calcining can be carried out for about 1 to about 10 hours at a temperature of from about 350° C. to about 550° C. Any suitable ambient atmosphere can be employed during calcining. Generally, calcining is conducted in an oxidizing atmosphere, such as air. Alternatively, an inert atmosphere, such as nitrogen or argon, or a reducing atmosphere, such as hydrogen or carbon monoxide, can be used.

According to one aspect of the present disclosure, the solid oxide material is treated with a source of halide ion, sulfate ion, or a combination of anions, optionally treated with a metal ion, and then calcined to provide the chemically-treated solid oxide in the form of a particulate solid. For example, the solid oxide material can be treated with a source of sulfate (termed a “sulfating agent”), a source of chloride ion (termed a “chloriding agent”), a source of fluoride ion (termed a “fluoriding agent”), or a combination thereof, and calcined to provide the solid oxide activator. Useful acidic activator-supports include, but are not limited to, bromided alumina, chlorided alumina, fluorided alumina, sulfated alumina, bromided silica-alumina, chlorided silica-alumina, fluorided silica-alumina, sulfated silica-alumina, bromided silica-zirconia, chlorided silica-zirconia, fluorided silica-zirconia, sulfated silica-zirconia, fluorided silica-titania, alumina treated with hexafluorotitanic acid, silica-coated alumina treated with hexafluorotitanic acid, silica-alumina treated with hexafluorozirconic acid, silica-alumina treated with trifluoroacetic acid, fluorided boria- alumina, silica treated with tetrafluoroboric acid, alumina treated with tetrafluoroboric acid, alumina treated with hexafluorophosphoric acid, a pillared clay, such as a pillared montmorillonite, optionally treated with fluoride, chloride, or sulfate; phosphated alumina or other aluminophosphates optionally treated with sulfate, fluoride, or chloride; or any combination of the above. Further, any of these activator-supports optionally can be treated with a metal ion.

The chemically-treated solid oxide can comprise a fluorided solid oxide in the form of a particulate solid. The fluorided solid oxide can be formed by contacting a solid oxide with a fluoriding agent. The fluoride ion can be added to the oxide by forming a slurry of the oxide in a suitable solvent such as alcohol or water including, but not limited to, the one to three carbon alcohols because of their volatility and low surface tension. Examples of suitable fluoriding agents include, but are not limited to, hydrofluoric acid (HF), ammonium fluoride (NH₄F), ammonium bifluoride (NH₄HF₂), ammonium tetrafluoroborate (NH₄BF₄), ammonium silicofluoride (hexafluorosilicate) ((NH₄)₂SiF₆), ammonium hexafluorophosphate (NH₄PF₆), hexafluorotitanic acid (H₂TiF₆), ammonium hexafluorotitanic acid ((NH₄)₂TiF₆), hexafluorozirconic acid (H₂ZrF₆), AlF₃, NH₄AlF₄, analogs thereof, and combinations thereof. Triflic acid and ammonium triflate also can be employed. For example, ammonium bifluoride (NH₄HF₂) can be used as the fluoriding agent, due to its ease of use and availability.

If desired, the solid oxide is treated with a fluoriding agent during the calcining step. Any fluoriding agent capable of thoroughly contacting the solid oxide during the calcining step can be used. For example, in addition to those fluoriding agents described previously, volatile organic fluoriding agents can be used. Examples of volatile organic fluoriding agents useful in this aspect of the disclosure include, but are not limited to, freons, perfluorohexane, perfluorobenzene, fluoromethane, trifluoroethanol, and the like, and combinations thereof. Calcining temperatures generally must be high enough to decompose the compound and release fluoride. Gaseous hydrogen fluoride (HF) or fluorine (F₂) itself also can be used with the solid oxide if fluorided while calcining. Silicon tetrafluoride (SiF₄) and compounds containing tetrafluoroborate (BF₄⁻) also can be employed. One convenient method of contacting the solid oxide with the fluoriding agent is to vaporize a fluoriding agent into a gas stream used to fluidize the solid oxide during calcination.

Similarly, in another aspect of this disclosure, the chemically-treated solid oxide comprises a chlorided solid oxide in the form of a particulate solid. The chlorided solid oxide is formed by contacting a solid oxide with a chloriding agent. The chloride ion can be added to the oxide by forming a slurry of the oxide in a suitable solvent. The solid oxide can be treated with a chloriding agent during the calcining step. Any chloriding agent capable of serving as a source of chloride and thoroughly contacting the oxide during the calcining step can be used, such as SiCl₄, SiMe₂Cl₂, TiCl₄, BCl₃, and the like, including mixtures thereof. Volatile organic chloriding agents can be used. Examples of suitable volatile organic chloriding agents include, but are not limited to, certain freons, perchlorobenzene, chloromethane, dichloromethane, chloroform, carbon tetrachloride, trichloroethanol, and the like, or any combination thereof. Gaseous hydrogen chloride or chlorine itself also can be used with the solid oxide during calcining. One convenient method of contacting the oxide with the chloriding agent is to vaporize a chloriding agent into a gas stream used to fluidize the solid oxide during calcination.

The amount of fluoride or chloride ion present before calcining the solid oxide generally is from about 1 to about 50% by weight, where the weight percent is based on the weight of the solid oxide, for example, silica-alumina, before calcining. According to another aspect of this disclosure, the amount of fluoride or chloride ion present before calcining the solid oxide is from about 1 to about 25% by weight, and according to another aspect of this disclosure, from about 2 to about 20% by weight. According to yet another aspect of this disclosure, the amount of fluoride or chloride ion present before calcining the solid oxide is from about 4 to about 10% by weight. Once impregnated with halide, the halided oxide can be dried by any suitable method including, but not limited to, suction filtration followed by evaporation, drying under vacuum, spray drying, and the like, although it is also possible to initiate the calcining step immediately without drying the impregnated solid oxide.

The silica-alumina used to prepare the treated silica-alumina typically has a pore volume greater than about 0.5 cc/g. According to one aspect of the present disclosure, the pore volume is greater than about 0.8 cc/g, and according to another aspect of the present disclosure, greater than about 1.0 cc/g. Further, the silica-alumina generally has a surface area greater than about 100 m²/g. According to another aspect of this disclosure, the surface area is greater than about 250 m²/g. Yet, in another aspect, the surface area is greater than about 350 m²/g.

The silica-alumina utilized in the present disclosure typically has an alumina content from about 5 to about 95% by weight. According to one aspect of this disclosure, the alumina content of the silica-alumina is from about 5 to about 50%, or from about 8% to about 30%, alumina by weight. In another aspect, high alumina content silica-alumina compounds can employed, in which the alumina content of these silica-alumina compounds typically ranges from about 60% to about 90%, or from about 65% to about 80%, alumina by weight. According to yet another aspect of this disclosure, the solid oxide component comprises alumina without silica, and according to another aspect of this disclosure, the solid oxide component comprises silica without alumina.

The sulfated solid oxide comprises sulfate and a solid oxide component, such as alumina or silica-alumina, in the form of a particulate solid. Optionally, the sulfated oxide is treated further with a metal ion such that the calcined sulfated oxide comprises a metal. According to one aspect of the present disclosure, the sulfated solid oxide comprises sulfate and alumina. In some instances, the sulfated alumina is formed by a process wherein the alumina is treated with a sulfate source, for example, sulfuric acid or a sulfate salt such as ammonium sulfate. This process is generally performed by forming a slurry of the alumina in a suitable solvent, such as alcohol or water, in which the desired concentration of the sulfating agent has been added. Suitable organic solvents include, but are not limited to, the one to three carbon alcohols because of their volatility and low surface tension.

According to one aspect of this disclosure, the amount of sulfate ion present before calcining is from about 0.5 to about 100 parts by weight sulfate ion to about 100 parts by weight solid oxide. According to another aspect of this disclosure, the amount of sulfate ion present before calcining is from about 1 to about 50 parts by weight sulfate ion to about 100 parts by weight solid oxide, and according to still another aspect of this disclosure, from about 5 to about 30 parts by weight sulfate ion to about 100 parts by weight solid oxide. These weight ratios are based on the weight of the solid oxide before calcining. Once impregnated with sulfate, the sulfated oxide can be dried by any suitable method including, but not limited to, suction filtration followed by evaporation, drying under vacuum, spray drying, and the like, although it is also possible to initiate the calcining step immediately.

According to another aspect of the present disclosure, the activator-support used in preparing the catalyst compositions of this disclosure comprises an ion-exchangeable activator-support, including but not limited to silicate and aluminosilicate compounds or minerals, either with layered or non-layered structures, and combinations thereof. In another aspect of this disclosure, ion-exchangeable, layered aluminosilicates such as pillared clays are used as activator-supports. When the acidic activator-support comprises an ion-exchangeable activator-support, it can optionally be treated with at least one electron-withdrawing anion such as those disclosed herein, though typically the ion-exchangeable activator-support is not treated with an electron-withdrawing anion.

According to another aspect of the present disclosure, the activator-support of this disclosure comprises clay minerals having exchangeable cations and layers capable of expanding. Typical clay mineral activator-supports include, but are not limited to, ion-exchangeable, layered aluminosilicates such as pillared clays. Although the term “support” is used, it is not meant to be construed as an inert component of the catalyst composition, but rather is to be considered an active part of the catalyst composition, because of its intimate association with the metallocene component.

According to another aspect of the present disclosure, the clay materials of this disclosure encompass materials either in their natural state or that have been treated with various ions by wetting, ion exchange, or pillaring. Typically, the clay material activator-support of this disclosure comprises clays that have been ion exchanged with large cations, including polynuclear, highly charged metal complex cations. However, the clay material activator-supports of this disclosure also encompass clays that have been ion exchanged with simple salts, including, but not limited to, salts of Al(III), Fe(II), Fe(III), and Zn(II) with ligands such as halide, acetate, sulfate, nitrate, or nitrite.

According to another aspect of the present disclosure, the activator-support comprises a pillared clay. The term “pillared clay” is used to refer to clay materials that have been ion exchanged with large, typically polynuclear, highly charged metal complex cations. Examples of such ions include, but are not limited to, Keggin ions which can have charges such as 7⁺, various polyoxometallates, and other large ions. Thus, the term pillaring refers to a simple exchange reaction in which the exchangeable cations of a clay material are replaced with large, highly charged ions, such as Keggin ions. These polymeric cations are then immobilized within the interlayers of the clay and when calcined are converted to metal oxide “pillars,” effectively supporting the clay layers as column-like structures. Thus, once the clay is dried and calcined to produce the supporting pillars between clay layers, the expanded lattice structure is maintained and the porosity is enhanced. The resulting pores can vary in shape and size as a function of the pillaring material and the parent clay material used. Examples of pillaring and pillared clays are found in: T. J. Pinnavaia, Science 220 (4595), 365-371 (1983); J. M. Thomas, Intercalation Chemistry, (S. Whittington and A. Jacobson, eds.) Ch. 3, pp. 55-99, Academic Press, Inc., (1972); U.S. Pat. Nos. 4,452,910; 5,376,611; and 4,060,480; the disclosures of which are incorporated herein by reference in their entirety.

The pillaring process utilizes clay minerals having exchangeable cations and layers capable of expanding. Any pillared clay that can enhance the polymerization of olefins in the catalyst composition of the present disclosure can be used. Therefore, suitable clay minerals for pillaring include, but are not limited to, allophanes; smectites, both dioctahedral (Al) and tri-octahedral (Mg) and derivatives thereof such as montmorillonites (bentonites), nontronites, hectorites, or laponites; halloysites; vermiculites; micas; fluoromicas; chlorites; mixed-layer clays; the fibrous clays including but not limited to sepiolites, attapulgites, and palygorskites; a serpentine clay; illite; laponite; saponite; and any combination thereof. In one aspect, the pillared clay activator-support comprises bentonite or montmorillonite. The principal component of bentonite is montmorillonite.

The pillared clay can be pretreated if desired. For example, a pillared bentonite is pretreated by drying at about 300° C. under an inert atmosphere, typically dry nitrogen, for about 3 hours, before being added to the polymerization reactor. Although an exemplary pretreatment is described herein, it should be understood that the preheating can be carried out at many other temperatures and times, including any combination of temperature and time steps, all of which are encompassed by this disclosure.

The activator-support used to prepare the catalyst compositions of the present disclosure can be combined with other inorganic support materials, including, but not limited to, zeolites, inorganic oxides, phosphated inorganic oxides, and the like. In one aspect, typical support materials that are used include, but are not limited to, silica, silica-alumina, alumina, titania, zirconia, magnesia, boria, thoria, aluminophosphate, aluminum phosphate, silica-titania, coprecipitated silica/titania, mixtures thereof, or any combination thereof.

The process of making these activator-supports may include precipitation, co-precipitation, impregnation, gelation, pore-gelation, calcining (at up to 900° C.), spray-drying, flash-drying, rotary drying and calcining, milling, sieving, and similar operations.

In an embodiment, an organoaluminum compound suitable for use in the present disclosure comprises an alkylaluminum compound. For example, the organoaluminum compound may comprise a trialkylaluminum compound, having the general formula AlR₃. Nonlimiting examples of trialkylaluminum compounds suitable for use in this disclosure include triisobutylaluminum (TiBA or TiBAl); tri-n-butylaluminum (TNBA); tri-octly-butylaluminum (TOBA); triethylaluminum (TEA); and/or other appropriate alkyl-aluminum complexes, and combinations thereof. Additionally, partially hydrolyzed alkylaluminum compounds and/or aluminoxanes, may be used. In an embodiment, the organoaluminum compound comprises a compound represented by the general formula:

Al(X⁵)ₚ(X⁶)_{q}

where X⁵ is a halide, hydrocarbyloxide group, hydrocarbylamino group or combinations thereof; X⁶ is a hydrocarbyl group having up to 18 carbon atom; p ranges from 0 to 2; and q is 3−p.

In an embodiment, the catalysts are chosen from compounds like those represented by the chemical structures MTE-A and MTE-B.

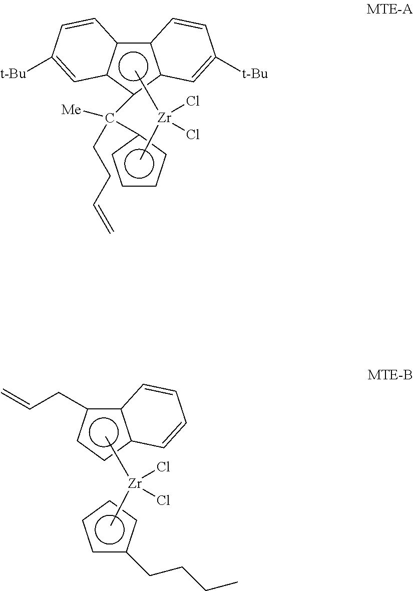

In an embodiment, a catalyst system suitable for use in the preparation of m-PE homopolymers of the type disclosed herein comprises a metallocene compound (e.g., MTE-A), an activator support (e.g., sulfated alumina); and an organoaluminum compound (e.g., TIBA).

Methods for preparation of m-PE homopolymers of the type described herein are disclosed for example in U.S. Pat. No. 9,018,329, the disclosure of which is incorporated by reference herein in its entirety.

In an embodiment, the core layer of the MPF comprises a high-density polyethylene (HDPE). Any HDPE compatible with the other components of the MPF may be used to prepare the core layer. In an embodiment, the HDPE is a homopolymer. It is to be understood that any inconsequential amount of comonomer may be present in the HDPE and the polymer still be considered a homopolymer. Herein, an inconsequential amount of a comonomer refers to an amount that does not substantively affect the properties of the polymer disclosed herein. For example, a comonomer can be present in an amount of less than about, 0.5 wt. %, 0.1 wt. %, or 0.01 wt. % based on the total weight of polymer. In an alternative embodiment, the HDPE is a copolymer. In an embodiment, the HDPE may be a copolymer comprising a polymer of ethylene with one or more comonomers such as, for example, alpha olefins. Examples of suitable comonomers include, but are not limited to, unsaturated hydrocarbons having from 3 to 20 carbon atoms such as propylene, 1-butene, 1-pentene, 1-hexene, 3-methyl-1-butene, 4-methyl-1-pentene, 1-heptene, 1-octene, 1-nonene, 1-decene, and mixtures thereof.

In an embodiment, an HDPE suitable for use in the core layer of the MPF has a polymer density of greater than about 0.940 g/cc, alternatively greater than 0.949 g/cc to or alternatively greater than about 0.954 g/cc as determined in accordance with ASTM D 1505.

In an embodiment, an HDPE suitable for use in the core layer of the MPF has a melt index equal to or less than about 2.0 g/10 min, alternatively from about 0.5 g/10 min to about 1.5 g/10 min, or alternatively from about 0.75 g/10 min to about 1.25 g/10 min as determined in accordance with ASTM D 1238.

In an embodiment, the HDPE is a metallocene-catalysed HDPE (m-HDPE). Alternatively, the m-HDPE is a PE homopolymer of the type described previously herein. In another embodiment, the HDPE is a chrome-catalyzed ethylene polymer (Cr-HDPE). In yet another embodiment, the HDPE is a Ziegler-Natta catalyzed ethylene polymer (ZN-HDPE). Herein, the term m-HDPE refers to a high-density polyethylene prepared using a catalyst comprising one or more metallocene-containing compounds. Catalysts comprising metallocene-containing compounds are disclosed for example in U.S. Pat Nos. 7,064,225; 7,226,886; 7,960,487; 7,956,139; and 7,799,721; each of which are incorporated herein by reference in their entirety. Herein, the term Cr-HDPE refers to a high-density polyethylene prepared using a catalyst comprising one or more chromium-containing compounds. Catalysts comprising chromium-containing compounds are disclosed for example in U.S. Pat Nos. 4,402,864; 4,877,763; and 7,799,721; each of which are incorporated herein by reference in their entirety. Herein, the term ZN-HDPE refers to a high-density polyethylene prepared using a Ziegler-Natta catalyst. Ziegler-Natta catalysts are described for example in U.S. Pat Nos. 7,449,530; 6,930,071; and 6,831,032; each of which is incorporated by reference herein in its entirety.

In an embodiment, the MPF additionally comprises an inner seal layer which functions to promote sealing between two layers of the MPF. The seal layer may be comprised of any polymeric material that functions to enhance sealing of the layers of the MPF and is compatible with other components of the MPF. In an embodiment, the seal layer comprises ethylene-based polymers, such as polyethylene in the form of low density polyethylene (LDPE), linear low density polyethylene (LLDPE), ultra low density polyethylene (ULDPE), medium density polyethylene (MDPE), high density polyethylene (HDPE), or cyclic polyolefin (COC); ethylene-based co-polymers, such as ethylene methyl acrylate copolymer (EMA), ethylene vinyl acetate copolymer (EVA), ethylene butyl acrylate copolymer (EBA), ethylene-ethyl acrylate (EEA), ethylene acrylic acid copolymer (EAA), ionomer resins, elastomeric co-polyesters, ethylene-methyl acrylic acid copolymers (EMAA), MAH-modified polyethylene, maleic anhydride modified EVA, MAH-EMA, polybutylene, or any combination thereof.

In an embodiment, a multilayer film structure is formed using the polymers disclosed herein and any suitable technology for preparation of a film. For example, the MPF may be produced by a coextrusion cast film process wherein molten polymers of the type disclosed herein are coextruded through a slot or die to form a thin, composite extruded sheet. The coextruded sheet or film is extruded onto a water cooled chill roll. The chill roll functions to immediately quench the sheet or film from its molten state to a solid state.

In an embodiment, the sheet or film may then be passed through rollers designed to stretch the sheet in differing axial directions to produce biaxially oriented films, which may be further trimmed and rolled for transport or storage.

In an embodiment, the MPF is formed through a blown film process. In a blown film process, plastic melt is extruded through an annular die, usually vertically, to form a walled tube. The size of the tube is a function of the blow-up ratio that is controlled by the amount of air introduced at the die. The bubble then moves upwards until it passes through nip rolls where the tube is flattened. This flattened tube is then collected in rolled form. In some cases the edges of the tube are slit forming two flat sheets which are then collected in roll form. Cooling of the blown film tube is accomplished through the use of an air ring which sits on top of the die and blows cool air against the outside surface of the tube. On higher output lines, fresh cooled air may be continuously circulated inside the bubble, allowing for greater output rates. This manner of cooling the bubble is known as Internal Bubble Cooling (IBC). Typically, the blow-up ratio between die and blown bubble would be 1.5 to 4 times the die diameter. The drawdown between the melt wall thickness and the cooled film thickness occurs in both radial and longitudinal directions and is easily controlled by changing the volume of air inside the bubble and by altering the take off speed of the line.

The MPF formed from polymer resins of this disclosure may be of any thickness desired by the user. For example, the MPF comprising at least 3 layers may have a thickness ranging from about 0.75 mils to about 3 mils; alternatively from about 1 mil to about 2.5 mils; or alternatively from about 1.5 mils to about 2.0 mils. The skin layer and seal layer of the MPF may each have a thickness of from about 5% to about 45% of the total MPF thickness, alternatively from about 7% to about 30%, or alternatively from about 10% to about 25%. For example, referring again to FIG. 1, the outer skin layer 20 may have a thickness of from about 5 to about 45% of the thickness of MPF 10, the inner seal layer 25 may have a thickness of from about 5 to about 45% of the thickness of MPF 10, and the one or more core layers 15 may comprise the remainder of the thickness of MPF 10, e.g., from about 10 to about 90% of the thickness of MPF 10.

In an embodiment, a MPF of the type described herein is formed into a multilayer structure wherein the outer skin layer comprises an m-HDPE of the type disclosed herein. In such an embodiment, the MPF comprises at least one HDPE core layer and an inner seal layer. The outer skin layer may be designated A and the core layer may be designated B. In an embodiment, the MPF has a film structure represented as A-B-A. In an alternative embodiment, the MPF has a film structure represented as A-B-C where C layer represents a seal layer.

In an embodiment, a MPF of the type disclosed herein may have an MVTR of less than or equal to about 0.50 grams-mil per 100 square inch per day (g-mil/100 in²/day), at a total film thickness of 1.25 mils. Alternatively, less than or equal to about 0.30 g-mil/100 in²/day at a total film thickness of 1.75 mils, alternatively less than or equal to about 0.2 g-mil/100 in²/day at 2 mils total film thickness or alternatively of from about 0.15 g-mil/100 in²/day to about 0.4 g-mil/100 in²/day at a thickness of from about 1.25 mil to about 2.0 mils. MVTR is measured in accordance with ASTM F 1249.

In an embodiment, a MPF of the type disclosed herein has an OTR of less than about 140 cubic centimeters per 100 square inch per day (cm³/100 in²/day) at a total film thickness of 1.6 mils, alternatively less than 135 cm³/100 in²/day at a total film thickness of 1.6 mils, alternatively less than 125 cm³/100 in²/day at a total film thickness of 1.6 mils; or alternatively of from about 80 cm³/100 in²/day to about 130 cm³/100 in²/day at a thickness of from about 1.4 mil to about 1.9 mil as measured in accordance with ASTM D3985.

In an embodiment, a MPF of the type disclosed herein may display improved optical properties. For example, said films may display reduced haze. Generally, haze refers to the cloudy appearance of a material cause by light scattered from within the material or from its surface. Herein, the values of haze disclosed refer to the percentage of transmitted light that scatters or deviates from an incident beam by more than 2.5° (angle degrees). The haze of a material can be determined in accordance with ASTM D1003 for a haze percentage of equal to or lower than 30%. A material having a haze percentage of greater than 30% can be determined in accordance with ASTM E167. In an embodiment, 1.6-mil MPF of type described herein may have a haze percentage of less about 30%; alternatively a MPF of the type disclosed herein may have a haze percentage of from about 10% to about 25% at a thickness of from about 1.4 mil to 1.9 mil.

The films produced from polymers of this disclosure may be used in the formation of any variety of end-use articles. Nonlimiting examples of end-use articles include for contents such as cereals, crackers, cheese, meat, etc. Other nonlimiting examples of end-use articles is a polymer sheet, which can then be thermoformed into an end use article such as a container, a cup, a tray, a pallet, a toy, or a component of another product.

### EXAMPLES

The subject matter having been generally described, the following examples are given as particular embodiments of the disclosure and to demonstrate the practice and advantages thereof. It is understood that the examples are given by way of illustration and are not intended to limit the specification of the claims to follow in any manner The following testing procedures were used to evaluate the various polymers and compositions.

MVTR, OTR, and haze were measured in accordance with ASTM F 1249, ASTM D3985 and ASTM D-1003 respectively. Haze measurement is determined with a haze-gard plus from BYK-Gardner or equivalent.

### Example 1

Barrier properties of MPFs of the type disclosed herein were investigated. Specifically, an m-HDPE and Cr-HDPE were coextruded and a three-layer blown film was prepared. The m-HDPE used is described in U.S. Pat. No. 9,018,329, the disclosure of which is incorporated by reference herein in its entirety. The film was prepared in an A-B-A structure where the skin layers, designated A, each comprised 25% of the total thickness of the MPF and were prepared from the aforementioned m-HDPE. The core layer, designated B, comprised 50% of the total thickness of the MPF and was prepared from a Cr-HDPE. The Cr-HDPE used was MARLEX 9659 which is a high density polyethylene commercially available from Chevron Phillips Chemical Company LP.

A total of five films, designated samples 1-5, were evaluated for MVTR, OTR, and haze in comparison to a three-layer film where each layer was formed from the Cr-HDPE (designated control). The OTR and haze of these films was determined and these results are presented in Table 1.

TABLE 1

| Sample | Control | 1 | 2 | 3 | 4 | 5 |
|---|---|---|---|---|---|---|
| Sample Gauge (mil) | 1.58 | 1.85 | 1.55 | 1.48 | 1.37 | 1.54 |
| OTR cm³/100 in²/day | 146 | 85 | 115 | 122 | 111 | 114 |
| Haze (%) | 52 | 19 | 13 | 13 | 16 | 18 |

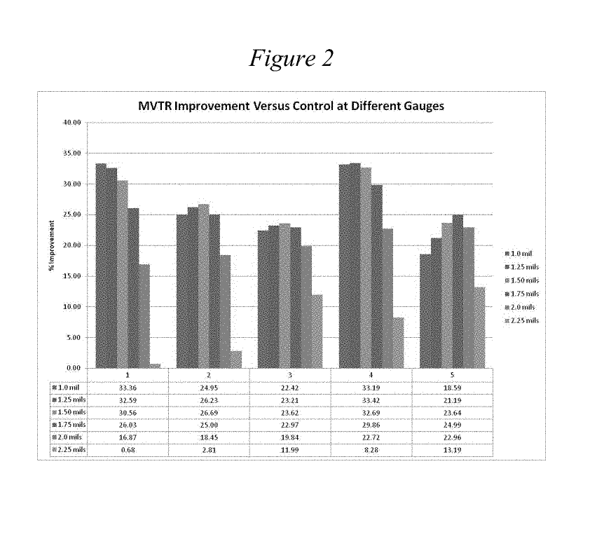

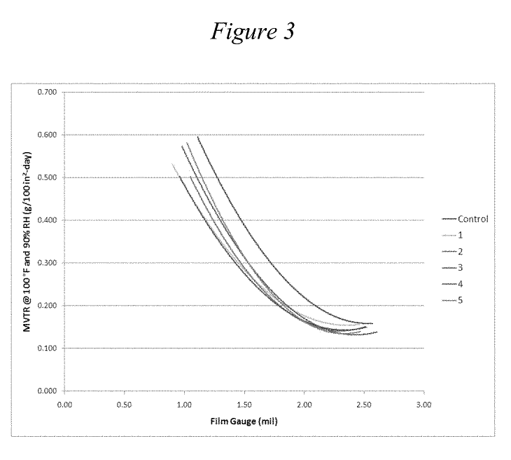

The MVTR was measured and the improvement in barrier performance, expressed as percent reduction in MVTR when compared to the control film, is presented in FIGS. 2. The MVTR versus gauge is plotted in FIG. 3 against the control. The results demonstrate that films featuring m-HDPE skin layers of the type disclosed herein displayed significant improvements in both barrier performance and clarity over the control. In addition, the haze number of the films prepared with m-HDPE skins was 50% or less than the control film. Additionally, the co-extruded MPFs having m-HDPE skin layers exhibited glossier surfaces that could prove advantageous in non-traditional barrier markets.

While embodiments of the invention have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference, to the extent that they provide exemplary, procedural or other details supplementary to those set forth herein.

1-20. (canceled)

21. A multilayer polymer film comprising an outer skin layer, an inner seal layer and at least one core layer disposed between the inner seal layer and outer skin layer, wherein the outer skin layer comprises a single-metallocene-catalyzed, unimodal ethylene homopolymer having a density of equal to or greater than about 0.945 g/cc, a melt index in a range of from equal to or greater than about 0.5 g/10 mm to equal to or less than about 4 g/10 min, and a molecular weight distribution of from about 2 to about 5, wherein the multilayer polymer film has a moisture vapor transmission rate of less than about 0.5 g-mil/100 in²/day at 1.25 mils total film thickness and an oxygen transmission rate of less than 140 cc/100 in²/day at 1.6 mils total film thickness,

22. The film of claim 21 wherein the core layer comprises a chrome-catalyzed polymer with a density greater than 0.940 g/cc and a melt index less than or equal to 2.0 g/10 min.

23. The film of claim 21 wherein the core layer comprises a Ziegler Natta-catalyzed polymer with a density greater than 0.940 g/cc and a melt index less than or equal to 2.0 g/10 min.

24. The film of claim 21 wherein the core layer comprises a metallocene-catalyzed polymer with a density greater than 0.940 g/cc and a melt index less than or equal to 2.0 g/10 min.

25. The film of claim 21 wherein the core layer comprises an ethylene copolymer or an ethylene homopolymer.

26. The film of claim 21 having a moisture vapor transmission rate less than 0.3 g-mil/100 in²/day at 1.75 mils total film thickness.

27. The film of claim 21 having a moisture vapor transmission rate of less than 0.2 g-mil/100 in²/day at 2 mils total film thickness.

28. The film of claim 21. having an oxygen transmission rate of less than 135 cc/100 in²/day at 1.6 mils total film thickness.

29. The film of claim 21 having an oxygen transmission rate of less than 125 cc/100 in²/day at 1.6 mils total film thickness.

30. The film of claim 21 wherein the film is a blown film.

31. The film of claim 21 wherein the film is a cast film.

32. The film of claim 21 having a haze of less than 30% at 1.6 mils total film thickness.

33. An article made from the film of claim 21.

34. A multilayer polymer film comprising a single-metallocene-catalyzed, high-density, unimodal polyethylene homopolymer skin layer having a melt index of greater than 2.0 g/10 min and a molecular weight distribution of from about 2 to about 5 and at least one core layer comprising a high-density polyethylene having a melt index of less than or equal to 2.0 g/10 min wherein the multilayer polymer film has a moisture vapor transmission rate of equal to about 0.50 grams-mil per 100 square inch per day (g-mil/100 in²/day), at a total film thickness of 1.25 mils and an oxygen transmission rate of less than 140 cc/100 in²/day at 1.6 mils total film thickness.

35. The film of claim 34 wherein the melt index is less than about 4 g/10 min.

36. The film of claim 34 having a moisture vapor transmission rate less than 0.3 g-mil/100 in²/day at 1.75 mils total film thickness.

37. The film of claim 34 having a moisture vapor transmission rate of less than 0.2 g-mil/100 in²/day at 2 mils total film thickness.

38. The film of claim 34 having a haze of from about 10% to about 25% at a thickness of from about 1.4 mil to about 1.9 mil.

39. An article made from the film of claim 34.

40. A multilayer polymer film comprising at least a skin layer and a core layer wherein the skin layer comprises a metallocene-catalyzed, unimodal ethylene homopolymer having a molecular weight distribution of from about 2 to about 5 wherein the metallocene-catalyzed ethylene polymer is provided from a catalyst composition comprising a single metallocene and an activator support and wherein the multilayer polymer film has a moisture vapor transmission rate of less than about 0.5 g-mil/100 in²/day at 1.25 mils total film thickness, an oxygen transmission rate of less than 140 cc/100 in²/day at 1.6 mils total film thickness, and a haze of less than 30% at 1.6 mils total film thickness.

41. The film of claim 40 wherein the metallocene-catalyzed ethylene polymer has a. density of equal to or greater than about 0.945 g/cc and a melt index equal to or greater than 0.5 g/10 min.

42. The film of claim 21 wherein the metallocene-catalyzed ethylene polymer has a. weight average molecular weight of from about 80 kg/mol to about 200 kg/mol.

43. The film of claim 21 wherein the metallocene-catalyzed ethylene polymer has a ratio of z-average molecular weight to weight average molecular weight of less than about 3.5.

44. The film of claim 40 wherein the metallocene-catalyzed ethylene polymer has a density of equal to or greater than about 0.955 g/cc and a melt index greater than 2.0 g/10 min.

45. The film of claim 40 wherein the metallocene-catalyzed ethylene polymer has a density of equal to or greater than about 0.960 g/cc

46. The film of claim 21 wherein the outer skin layer has a density of equal to or greater than about 0.955 g/cc and a melt index greater than 2.0 g/10 min.

47. The film of claim 21 wherein the outer skin layer has a density of equal to or greater than about 0.960 g/cc.

48. The film of claim 34 wherein the outer skin layer has a density of equal to or greater than about 0.955 g/cc.

49. The film of claim 34 wherein the outer skin layer has a density of equal to or greater than about 0.960 g/cc.
